(19) United States
(12) Patent Application Publication
(10) Pub. No.: US 2025/0183476 A1
(43) Pub. Date: Jun. 5, 2025

(54) SYSTEM AND METHOD FOR PREDICTING DEFECTS IN SEPARATOR COATINGS

(71) Applicant: Millibatt, Inc.

(72) Inventors: Kyung Rak Jang, Los Angeles, CA (US); Sohyun An, Los Angeles, CA (US); Leland Smith, Los Angeles, CA (US); Janet Hur, Los Angeles, CA (US)

(21) Appl. No.: 19/042,874

(22) Filed: Jan. 31, 2025

Related U.S. Application Data
(63) Continuation-in-part of application No. 18/134,501, filed on Apr. 13, 2023, now Pat. No. 12,040,504.
(60) Provisional application No. 63/680,478, filed on Aug. 7, 2024.
(60) Provisional application No. 63/627,761, filed on Jan. 31, 2024.
(60) Provisional application No. 63/330,763, filed on Apr. 13, 2022.

(51) Int. Cl. H01M 50/403; G01N 21/17; G01N 21/47; G01N 21/84

(52) U.S. Cl. CPC H01M 50/403; G01N 21/4788; G01N 2021/1765; G01N 2021/8427

(57) ABSTRACT

One variation of a method includes: advancing an electrode through a coating zone; at a spray nozzle facing the coating zone, depositing a separator material onto the electrode according to a set of spray parameters to form a separator coating on the electrode; accessing an inspection signal representing a characteristic of the separator coating applied to the electrode; based on the inspection signal, interpreting a value of the characteristic of the separator coating applied to the electrode; modifying a second set of spray parameters to compensate for the value of the characteristic of the separator coating applied to the electrode; advancing the electrode through a second coating zone downstream of the coating zone; and at a second spray nozzle facing the second coating zone, depositing the separator material onto the separator coating on the electrode according to the second set of spray parameters to form a second separator coating.

### CROSS-REFERENCE TO RELATED APPLICATIONS

This Application claims the benefit of U.S. Provisional Application Nos. 63/680,478, filed on 7 Aug. 2024, and 63/627,761, filed on 31 Jan. 2024, each of which is incorporated in its entirety by this reference.

This Application is a continuation-in-part of U.S. Pat. No. 12,040,504, filed on 13 Apr. 2023, which claims the benefit of U.S. Provisional Application No. 63/330,763, filed on 13 Apr. 2022, each of which is incorporated in its entirety by this reference.

This Application is also related to U.S. Pat. No. 11,476,549, filed on 19 Aug. 2021, and U.S. Pat. No. 11,411,289 filed on 19 Aug. 2021, each of which is incorporated in its entirety by this reference.

### TECHNICAL FIELD

This invention relates generally to the field of battery technologies and, more specifically, to a new and useful method for predicting defects in separator coatings in the field of battery technologies.

### BRIEF DESCRIPTION OF THE FIGURES

FIG. 1 is a flowchart representation of a method; and

FIG. 2 is a flowchart representation of one variation of the method;

FIG. 3 is a flowchart representation of one variation of the method;

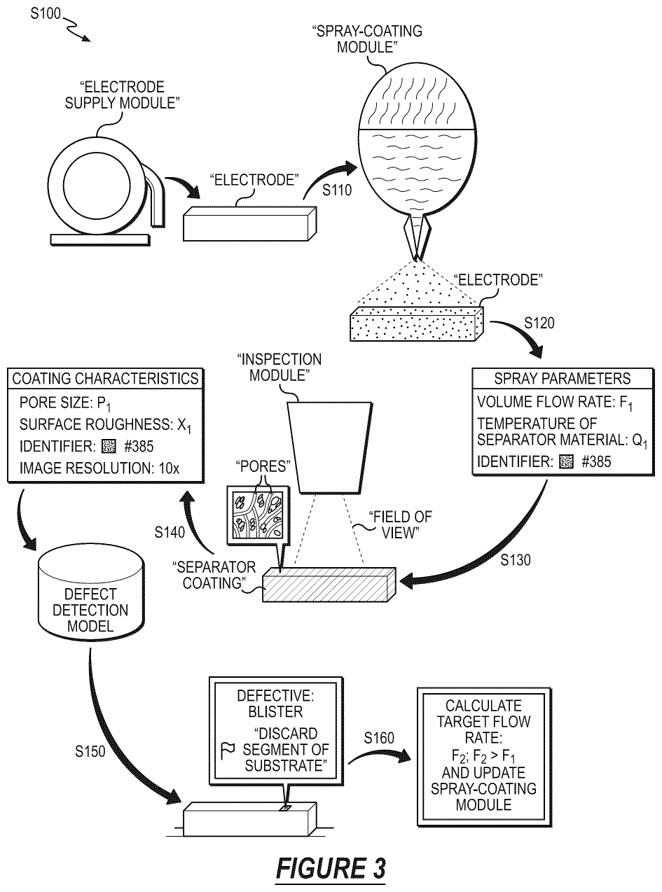

FIG. 4 is a flowchart representation of one variation of the method;

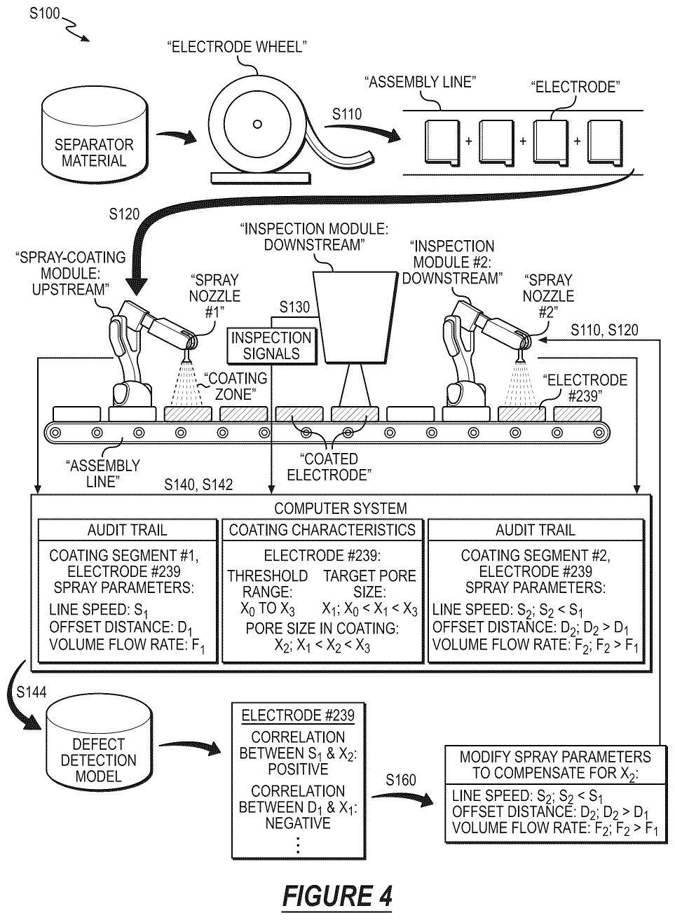

FIG. 5 is a flowchart representation of one variation of the method; and

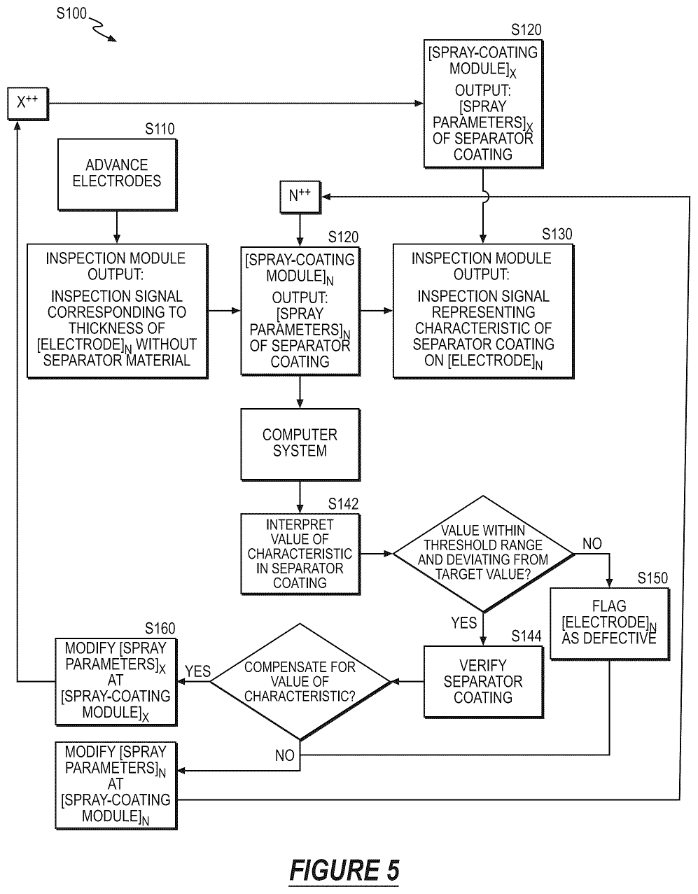

FIG. 6 is a flowchart representation of one variation of the method.

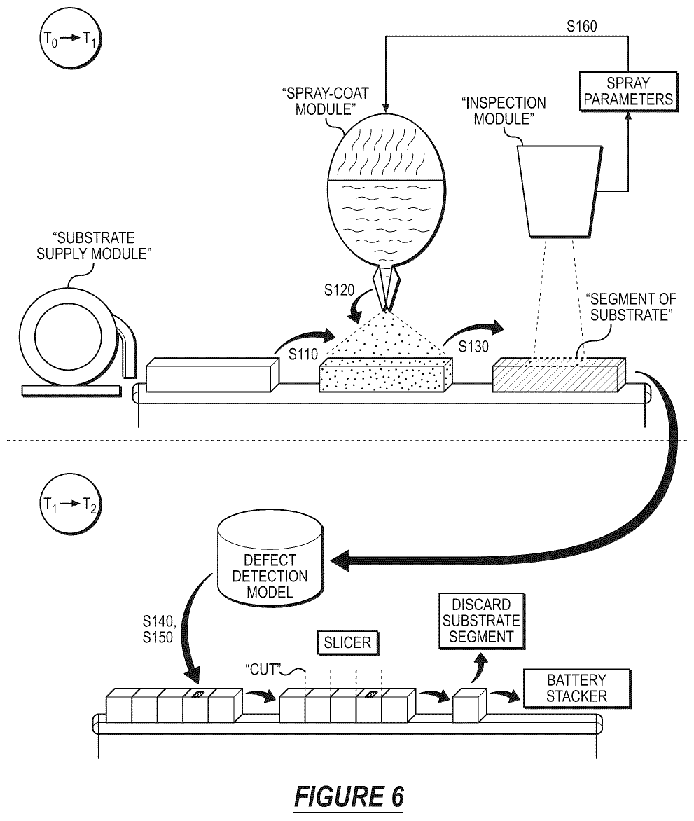

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

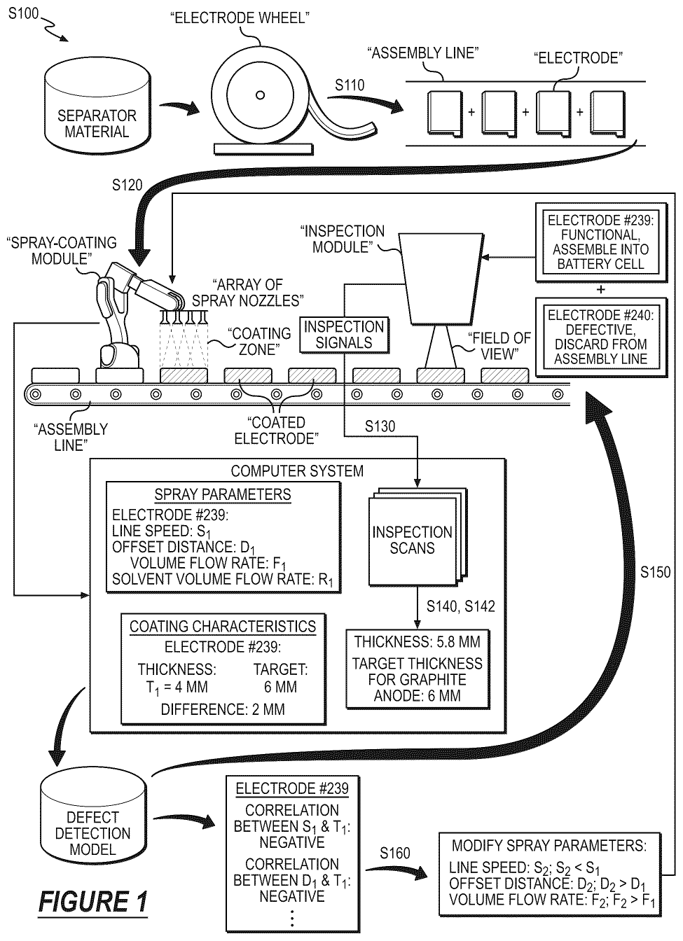

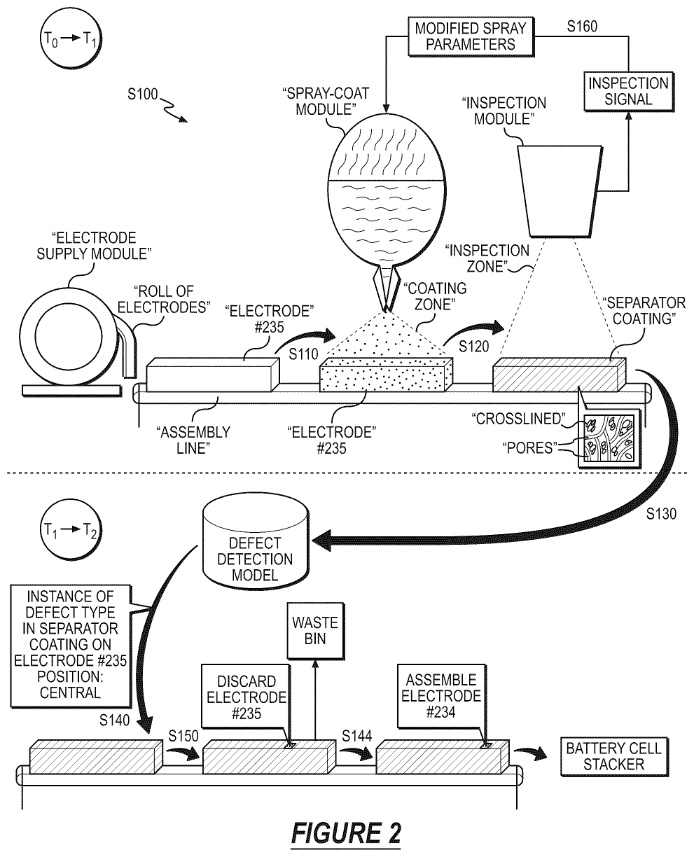

As shown in FIGS. 1 and 2, a method S100 includes, during a processing cycle: advancing a sequence of electrodes through a first coating zone in Block S110; at a first spray nozzle facing the first coating zone, dispensing a first volume of a separator material onto a first electrode, in the sequence of electrodes and occupying the first coating zone, according to a first set of spray parameters to form a first separator coating on the first electrode in Block S120; accessing a first inspection signal captured by an inspection module following deposition of the separator material onto the first electrode, the first inspection signal representing characteristics of the first separator coating applied to the first electrode in Block S130; and, based on the first inspection signal, detecting a first instance of a first defect type in the first separator coating on the first electrode in Block S140.

The method S100 further includes, in response to detecting the first instance of a first defect type in the first separator coating on the first electrode: in response to a first position of the first instance of the first defect type in the first separator coating on the first electrode intersecting a first electrode interface area defined for the first electrode, flagging the first electrode as defective in Block S150; and modifying the first set of spray parameters to reduce likelihood of a second instance of the first defect type in a second separator coating on a second electrode in the sequence of electrodes in Block S160.

### 1.1 Variation: Verification of Separator Coating

One variation of the method S100 includes: advancing a sequence of electrodes through a coating zone in Block S110; at a first spray nozzle facing the coating zone, depositing a first volume of a separator material onto a first electrode, in the sequence of electrodes and occupying the coating zone, according to a first set of spray parameters to form a first separator coating on the first electrode in Block S120; accessing a first inspection signal captured by an inspection module following deposition of the first volume of the separator material onto the first electrode, the first inspection signal representing a first characteristic of the first separator coating applied to the first electrode in Block S130; and, based on the first inspection signal, interpreting a first value of the first characteristic of the first separator coating applied to the first electrode in Block S142.

This variation of the method S100 further includes: in response to the first value of the first characteristic of the first separator coating applied to the first electrode falling within a first threshold range and deviating from a first target value within the first threshold range: verifying the first separator coating applied to the first electrode in Block S144; and modifying the first set of spray parameters to reduce a difference between a second value of the first characteristic of a second separator coating applied to a second electrode and the first target value in Block S160.

### 1.2 Variation: Downstream Spray Parameter Modification

One variation of the method S100 includes: advancing a first electrode through a first coating zone in Block S110; at a first spray nozzle facing the first coating zone, depositing a first volume of a separator material onto the first electrode occupying the first coating zone, according to a first set of spray parameters to form a first separator coating on the first electrode in Block S120; accessing a first inspection signal captured by an inspection module following deposition of the separator material onto the first electrode, the first inspection signal representing a first characteristic of the first separator coating applied to the first electrode in Block S130; based on the first inspection signal, interpreting a first value of the first characteristic of the first separator coating applied to the first electrode in Block S140; and modifying a second set of spray parameters to compensate for the first value of the first characteristic of the first separator coating applied to the first electrode in Block S160.

This variation of the method S100 further includes: advancing the first electrode through a second coating zone downstream the first coating zone in Block S110; and, at a second spray nozzle facing the second coating zone, depositing a second volume of the separator material onto the first separator coating on the first electrode occupying the second coating zone, according to the second set of spray parameters to form a second separator coating over the first separator coating on the first electrode in Block S120.

### 2. Applications

Generally, an electrode supply module, a spray-coating module, an in-line inspection module, and a computer system (hereinafter “the system”) can cooperate to execute Blocks of the method S100: to deposit a volume of separator material as an aerosol (or a “spray,” “constellation,” “mist,” or “cloud” of separator material droplets) over an electrode (e.g., a cathode, an anode, an electrode) to form a thin separator coating (e.g., a discrete separator layer, a permeable separator membrane, an aerogel) on the electrode.

The system can further execute Blocks of the method S100: to access inspection signals representing surface characteristics of a segment of an electrode following deposition of the separator material; to automatically derive coating characteristics of the separator coating—indicating defects that may result in electrical shorts when the electrode is subsequently assembled into a battery cell—from these inspection signals; and to identify the electrode as defective and flag the electrode for removal accordingly in near real time (e.g., as the electrode exits the system) and prior to assembly of the electrode into a battery cell (e.g., a two-dimensional or three-dimensional battery for an electric vehicle, a wearable device, a cellular device, or a battery-operated tool).

The system can thus execute Blocks of the method S100 substantially in real time to record and process an inspection signal (e.g., an image, a scan, a light diffraction pattern, reflected light) representing surface characteristics of the separator coating on the electrode in order to automatically detect features (e.g., coating characteristics, topographical features) of the separator coating representative of a (possible) functional defect. The system 100 can then flag this defective separator-coated electrode for rejection or removal prior to assembly into a battery cell in a next production segment, thereby: avoiding assembly and distribution of batteries containing separator defects (e.g. tears, pinholes, bubbles, blisters, delamination, wrinkles), which may otherwise result in internal discharge, battery failures, or fires; avoiding allocation of additional resources to complete assembly of batteries containing defective separator-coated electrodes; avoiding charging of batteries that contain defective separators following assembly; and/or avoiding requirements for extensive testing for presence of defects following assembly and charging of batteries.

In particular, the system can implement a defect detection model—such as a deep learning model executing an artificial neural network—configured to detect a common set of separator coating defects that yield battery cell failures and to generate a confidence score for each segment electrode exhibiting a defect. For example, the system can implement the defect detection model: to detect a defect in a separator coating from an inspection signal, representing surface characteristics of the separator coating on a segment of an electrode, captured by an optical sensor arranged in the inspection module; and to output a classification of the defect and an associated confidence score. The system can then assign the confidence score to an identifier, arranged on the electrode and selectively discard the defective electrode prior to assembly into a battery cell or convey the electrode to a battery cell production stage according to the confidence score.

### 2.1 Closed-Loop Coating Application Parameters for Defect Avoidance

Furthermore, the system can execute Blocks of the method S100: to record a set of characteristics of the separator coating on the electrode interpreted from an inspection signal during inspection of the coated electrode; access a target value corresponding to an electrode type and/or a material type of the electrode for each coating characteristic; and identify the electrode as functional responsive to a particular coating characteristic approximating (e.g., falling within a tolerance range of) the target value.

The system can then: derive a relationship (e.g., a positive correlation, a negative correlation) between the set of spray parameters and the particular coating characteristic; modify the set of spray parameters to generate a new set of spray parameters according to these correlations; and automatically implement the new set of spray parameters at the spray-coating module in order to reduce a difference between similar coating characteristics and the target value for subsequent electrode segments.

Alternatively, the system can: identify the electrode as defective responsive to the particular coating characteristic exceeding the target value; implement the defect detection model to detect and flag defects within the separator coating; and identify the electrode as defective.

For example, the system can: record a temperature of separator material at the spray nozzle of the spray-coating module during deposition of separator material droplets onto an electrode in an assembly line; record an inspection signal representing surface characteristics of the separator coating on an electrode; derive a haze value (e.g., reflected light) of this section of the separator coating based on the inspection signal; identify the haze value deviating from a target haze value; derive a positive correlation between the temperature of the separator material and the haze value of the separator coating; calculate a target temperature of the separator material at the spray nozzle based on the positive correlation; and trigger a heater, coupled to the spray-coating module, to heat the separator material toward the target temperature. Thus, the system can selectively increase or decrease the temperature of the separator material in order to prevent formation of a separator coating exhibiting a similar haze value, that may develop into a defect over time, during deposition of an nth volume of separator material onto an n^{th} electrode in the assembly line.

Therefore, the system can execute Blocks of the method S100: to reduce the volume of discarded electrodes during production of battery cells; and to enable rapid and autonomous inspection of separator coatings on electrodes in-line with an assembly line in order to identify and selectively discard defective electrodes or to guide selective, more resource-intensive inspection and testing of electrodes to identify functionally defective electrodes.

The method S100 is described herein as executed by the system: to deposit a volume of separator material as an aerosol over an electrode to form a thin separator coating on the electrode; to automatically derive coating characteristics of the separator coating from inspection signals; to identify the electrode as functional or defective; and flag the electrode accordingly. However, the system can similarly execute Blocks of the method S100: to deposit a volume of separator material as an aerosol over a segment of a substrate—including an electrode in a sequence of electrodes—to form a thin separator coating on the segment of the substrate; to automatically derive coating characteristics of the separator coating from inspection signals; to identify the segment of the substrate as functional or defective; and to flag the segment of the substrate accordingly.

### 2.2 Configurations

In one implementation, the system includes a spray-coating module configured to spray-coat separator material onto individual electrodes in a sequence of electrodes and an inspection module, arranged downstream of the spray-coating module, configured to identify and flag individual defective electrodes, in the sequence of electrodes, moving along an assembly line.

In another implementation, the system includes: a set of spray-coating modules; and a set of inspection modules arranged downstream of the set of spray-coating modules. For example, the system can include a set of (e.g., three) spray-coating modules configured to spray-coat separator material onto corresponding electrodes in a sequence of electrodes and a set of (e.g., three) inspection modules configured to identify and flag sets of defective coated electrodes passing along the single assembly line. Each inspection module, in the set of inspection modules, can automatically modify spray parameters for a corresponding spray-coating module, in the set of spray-coating modules, in order to reduce frequency of similar defects on subsequent electrodes in the sequence of electrodes.

### 3. System

The system includes: an electrode supply module; a spray-coating module; and an inspection module. The electrode supply module includes an electrode roll (e.g., an electrode reel, an anode reel, a cathode reel) configured to convey an electrode tape including a sequence of electrodes to the spray-coating module. The spray-coating module includes: a chassis; a multi-axis stage (e.g., a roll-to-roll handling subsystem); a spray nozzle and a coating supply subsystem configured to selectively supply separator material in a liquid state (e.g., a polymer-polymer-solvent liquid mixture) from a reservoir to the spray nozzle; a gas regulator; a set of heaters; and a set of sensors. The inspection module includes: an optical sensor; a wireless communication module; and a controller.

### 3.1 Spray-Coating Module

Generally, the spray-coating module is configured to spray-coat (e.g., deposit, dispense) volumes of the separator material onto an electrode occupying the coating zone.

As described in U.S. patent application Ser. No. 18/134,501, filed on 13 Apr. 2023, a spray coating system can include: a chassis; a multi-axis stage; a spray nozzle; a coating supply subsystem; a gas regulator; a set of heaters; and a set of temperature sensors coupled to the coating supply subsystem.

The chassis defines a coating zone and is arranged about the spray-coating module. The coating supply subsystem is supported by the multi-axis stage and includes: a vessel configured to contain a gaseous environment above a reservoir configured to contain the separator material in a liquid state (e.g., polymer-polymer-solvent liquid mixture); a first heater configured to heat the reservoir of separator material in the liquid state; a spray nozzle coupled to the reservoir, facing an electrode, and configured to spray-coat a volume of the separator material from the reservoir over an electrode; a second heater coupled to the spray nozzle and configured to heat the separator material prior to spray-coating the electrode; and a valve interposed between the reservoir and the spray nozzle.

The gas regulator is coupled to the coating supply subsystem and is configured to adjust a pressure of gas within the vessel of the coating supply subsystem. In one variation, the gas regulator can increase pressure of gas within the vessel and through the spray nozzle to remove excess separator material that may collect within the spray nozzle over a period of time (e.g., one week, three weeks, one month).

The temperature sensors can include a set of temperature sensors configured to output signals corresponding to temperatures of the separator material at the reservoir, temperatures of the separator material at the spray nozzle, and temperatures of the electrode.

In one variation, the spray-coating system includes a roll-to-roll handling subsystem supporting the chassis and configured to feed an electrode roll between a set of rollers for deposition of volumes of separator material over individual electrodes, in the electrode roll, along an assembly line via the spray nozzle.

### 3.1.1 Spray Nozzle

Generally, the spray nozzle is coupled to the reservoir and configured to spray-coat a volume of the separator material from the reservoir over an electrode moving along the battery cell assembly line.

In one implementation, the spray coating module includes an electrostatic charge unit (e.g., an electrostatic electrode) coupled to the spray nozzle and configured to generate an electrostatic field, between the spray nozzle and a surface of an electrode, that couples to and imparts an electrical charge onto separator material droplets within the volume of separator material. In this implementation, the controller can: trigger a driver to supply current to the electrostatic charge unit to generate an electrostatic field that couples to and imparts an electrical charge in a first direction onto separator material droplets within the volume of separator material; and activate the spray nozzle to deposit the volume of the separator material onto an electrode to form a separator coating that encapsulates all edges of the electrode. The controller can further: monitor a voltage or current supplied to the electrostatic charge unit from an electrostatic generator; and selectively deactivate the electrostatic generator to prevent electrical sparks and separator material overspray proximal the electrode.

In another implementation, the spray coating module includes an ultrasonic spray nozzle configured to spray-coat a constellation of separator material droplets onto an electrode to form a separator coating on the electrode at an ultrasonic frequency. Thus, the ultrasonic nozzle can deposit a constellation of separator material droplets onto the electrode to encapsulate all edges of the electrode (e.g., anode, cathode).

In yet another implementation, the coating supply subsystem can include a set of spray nozzles coupled in parallel by a valve and longitudinally offset by a pitch distance (e.g., 50 millimeters) such that each spray nozzle in the set of spray nozzles can concurrently spray-coat separator material onto a corresponding electrode, in an electrode tape, to form a uniform separator coating on the corresponding electrode.

Additionally or alternatively, the spray-coating module can include a set of (e.g., 3) spray nozzles: connected in parallel by a solenoid valve; defining a set of (e.g., 3) coating zones; and configured to spray-coat separator material onto a corresponding electrode in a sequence of electrodes within each coating zone. In this variation, the system 100 can concurrently batch process a sequence of electrodes during a processing cycle.

However, the spray-coating module can include any other type of spray nozzle that can dispense a volume of separator material in any other way onto an electrode occupying a coating zone.

### 3.1.2 Other Sensors

In one implementation, the spray-coating module further includes: an optical sensor, such as a visible light camera (e.g., an RGB camera) that captures images (e.g., digital photographic images) of a coated electrode occupying the coating zone; a depth sensor, such as a confocal displacement sensor, configured to output inspection signals (e.g., depth images); and an identifier scanner (e.g., a barcode scanner) configured to read an identifier arranged on an electrode.

Alternatively, the spray-coating module can include a set of optical fiducials arranged on and/or near the coating zone. The computer system can implement computer vision, machine learning, and/or machine vision techniques to identify the set of optical fiducials in a color image captured by the optical sensor and to transform sizes, geometries (e.g., distortions from known geometries), and/or positions of the set of optical fiducials within the color image into a depth map, into a three-dimensional color image, or into a three-dimensional measurement space for the color image, such as by passing the color image into a neural network.

In one variation, the spray-coating module includes: a distance sensor (e.g., a one-dimensional confocal displacement sensor); a laser light scanner configured to output signals corresponding to a spray pattern of separator material from the spray nozzle; a flying spot scanner configured to read a thickness of the separator coating on an electrode; an ultraviolet radiation sensor (e.g., a radiometer); a humidity sensor, such as mounted to the multi-axis stage or the coating supply subsystem proximal the spray nozzle and facing the coating zone; and/or a barcode scanner configured to read an identifier, arranged on the electrode, through the separator coating. However, the spray-coating module can include any other ambient or optical sensor.

In another variation, the confocal displacement sensor is configured to output inspection signals corresponding to surface characteristics of a section of a separator coating on a segment of an electrode occupying the coating zone and transmit these inspection signals to a computer system to derive spray parameters of the section of the separator coating on the electrode, as further described below.

### 3.2 Inspection Module

The system includes an inspection module arranged downstream the spray-coating module and configured to transmit inspection signals (e.g., thicknesses, photographic images, depth images, diffraction light patterns) of a separator coating on the electrode—paired with insights derived from these inspection signals—to the computer system.

In one implementation, the inspection module includes: an optical sensor, such as a visible light camera, a color camera, a light spectrometer, a laser light scanner, defining an inspection zone and that captures images (e.g., digital photographic images) of coated electrodes; a wireless communication module configured to broadcast image data recorded by the optical sensor; and a controller configured to trigger the optical sensor to record an image and then queue the wireless communication module to broadcast the image to a computer system for processing.

In one variation, the inspection module includes: a platform that receives a coated electrode; and an optical sensor, such as a light spectrometer that transmits and captures light reflectivity of a coated electrode placed on the platform. In this variation, the wireless communication module offloads light reflectivity data recorded by the optical sensor and the controller queues the wireless communication module to broadcast the light reflectivity data to the computer system for processing.

### 3.3 Computer System

Blocks of the method S100 can be executed by a computer system, such as: locally on an inspection module at which inspection signals of coated electrodes are recorded via the optical sensor; locally near an assembly line populated with spray-coating modules and inspection modules; within a manufacturing space or manufacturing center occupied by this assembly line; or remotely at a remote server connected to spray-coating modules and inspection modules via a computer network (e.g., the Internet), etc. The computer system can also interface directly with sensors coupled to the spray-coating module and/or other sensors arranged along or near the assembly line to collect non-visual manufacturing and test data (e.g., spray parameters) or retrieve these data from the controller arranged in an inspection module.

Furthermore, the computer system can interface with databases containing other non-visual manufacturing data for electrodes produced on this assembly line, such as: test data for batches of electrodes supplied to the assembly line; supplier, manufacturer, and production data for electrodes supplied to the assembly line; etc.

In one implementation, the computer system: derives a relationship between visual and non-visual features for an electrode material type (e.g., a graphite anode, a silicon anode, a lithium iron phosphate cathode, a nickel cobalt manganese cathode); derives correlations between defects detected on coated electrodes of this material type, visual data (e.g., coating characteristics of coated electrodes), and non-visual data (e.g., spray parameters) collected during production of these coated electrodes; and/or correlates coating characteristics derived from inspection signals of coated electrodes to spray parameters (e.g., root causes of defects) based on visual and non-visual data collected during production of these coated electrodes.

### 4. Processing Cycle

Block S110 of the method S100 recites advancing a sequence of electrodes through a first coating zone. Generally, in Block S110, the system advances a sequence of electrodes of a particular type (e.g., anode, cathode, copper, aluminum) from a roll (e.g., a tape, a reel) at a continuous speed along a battery cell assembly line.

In particular, at the start of a processing cycle (e.g., a spray deposition cycle, a manufacturing cycle, a production cycle), the system resets the multi-axis stage to a home position facing the coating zone. The electrode supply module then conveys a sequence of electrodes (e.g., sheets, webs or a continuous strip of electrodes)—each electrode marked with an optical code (e.g., a serial number, a QR code, a barcode)—to the spray-coating module such that an electrode, in the sequence of electrodes, occupies the coating zone. The system then initiates the processing cycle. The multi-axis stage: includes an array of spray nozzles (e.g., three, four, five) traversable along a Y-axis and a Z-axis; and is arranged above a roll-to-roll conveyor moving electrodes along an X-axis of an assembly line.

In one example, the electrode supply module conveys a sequence of cathodes to the spray-coating module such that a cathode, in the sequence of cathodes, occupies the coating zone. The system then initiates the coating segment.

In another example, the electrode supply module conveys a sequence of anodes to the spray-coating module such that an anode, in the sequence of anodes, occupies the coating zone. The system then initiates the coating segment.

### 4.1 Coating Segment

Block S120 of the method S100 recites, at a first spray nozzle, depositing a separator material onto the first electrode, occupying a coating zone along the battery cell assembly line, to form a first separator coating on the first electrode. Generally, in Block S120, the system 100 can receive an electrode in a coating zone and deposit droplets of separator material onto the electrode, via a spray nozzle, to form a separator coating on the electrode.

In one implementation, the system: triggers the multi-axis stage to locate the coating supply subsystem facing the electrode occupying the coating zone; and deposits (or “spray-coats”) a volume of the separator material as an aerosol across all surfaces and/or edges of an electrode (e.g., an electrode, an anode, a cathode) to form a separator coating, such as an aerogel, a discrete separator layer, or a permeable separator membrane on the electrode via the spray nozzle.

In one variation, the system: receives an electrode within a coating zone along the battery cell assembly zone; drives a voltage difference between the spray nozzle, coupled to the reservoir of the separator material in a liquid state, and the electrode (e.g., via the electrostatic charge unit coupled to the spray nozzle); and activates the first spray nozzle to dispense a volume of separator material over the electrode to electrically-charge separator material droplets within the volume of separator material existing at the spray nozzle to electrostatically draw these separator material droplets onto the electrode and thus apply the volume of separator material across the electrode via the voltage difference.

Furthermore, the system can spray-coat a volume of the separator material—including a solvent, a first polymer, a second polymer-onto the electrode via the spray nozzle. The system can then implement methods and techniques described in U.S. patent application Ser. No. 18/134,501, filed on 13 Apr. 2023: to heat the electrode and the volume of separator material to evaporate the solvent out of the volume of the separator material; and irradiate the volume of the separator material, located on the electrode, to crosslink the first polymer and form a separator coating on the electrode. The separator coating defines an open-celled network of pores that are sized: to promote uniform and rapid ion transport; to prevent defect formation on the electrode; to control mechanical properties of the electrode; and to thus prevent electrical shorts between an anode and a cathode in a battery cell, such as due to dendrite growth from the anode into the separator coating or due to electrically conductive particulate impurities in the electrolyte of the battery cell.

In another implementation, the system: receives a reel of electrodes, such as anodes and cathodes, within the coating zone from the electrode supply module; spray-coats all exposed surfaces and edges of the reel of electrodes to encapsulate the electrode reel with a contiguous separator coating; and cuts an individual electrode from the reel of electrodes, such that the separator coating encapsulates first sides of the individual electrode and renders second sides of the individual electrode exposed. The system can initiate an inspection segment to detect possible defects in the separator coating on first sides of the individual electrode and/or second exposed sides of the individual electrode via a defect detection model, as further described below.

### 4.1.1 Spray Parameters

Generally, prior to or during the coating segment, the system can record a set of spray parameters proximal (e.g., nearby, within a threshold distance of) the electrode. In particular, the system can record a set of spray parameters proximal (e.g., nearby, within a threshold distance of) the electrode including: a temperature of separator material at the spray nozzle; a volume flow rate of separator material through the spray nozzle; an air pressure/gas pressure of the spray nozzle; an ultrasonic atomization power; a temperature of separator material occupying a liquid state in the reservoir; a temperature of air proximal the electrode occupying the coating zone; an offset distance between the spray nozzle and a surface of the electrode; a reel speed (e.g., a line speed) of an electrode tape entering the coating zone; a movement rate of the nozzle gantry; a production rate of coated electrodes; an ultrasonic frequency of the spray nozzle; and/or an electrostatic voltage difference between the spray nozzle and an electrode. The system can then link these spray parameters to an identifier arranged on the electrode or generate an electronic file linking manufacturing data and spray parameters to the electrode via the identifier.

In one implementation, the system: records a set of spray parameters, proximal a particular electrode, and a corresponding timestamp during the coating segment; and stores the set of spray parameters associated with the timestamp in a spray parameter database. Then, during an inspection segment, the inspection module can retrieve the set of spray parameters for this particular electrode from the database according to the timestamp.

In another implementation, the system: interprets a set of spray parameters, proximal the electrode, during the coating segment; identifies an optical code (e.g., a barcode, a QR code, a serial number) arranged on the electrode; and links an electrode identifier, interpreted from the optical code, to these spray parameters. For example, the system can receive a set of signals from a temperature sensor coupled to the reservoir and from a distance sensor coupled to the coating supply subsystem. Based on the set of signals, the system can: interpret a temperature of separator material occupying a liquid state in the reservoir; and interpret an offset distance between the spray nozzle and a top surface of an electrode occupying the coating zone.

The system can further: deposit a volume of the separator material across all surfaces and/or edges of an electrode to form a thin separator coating on the electrode via the spray nozzle; read a QR code, through the separator coating, arranged on the electrode via a barcode scanner facing the electrode; link the temperature of the separator material and the offset distance between the spray nozzle and the top surface of the electrode to an electrode identifier defined in the QR code; and convey the coated electrode to the inspection module to capture inspection signals of the separator coating on the electrode during an inspection segment.

### 4.1.2 Audit Trail

Additionally, the system can record a particular time value corresponding to the coating segment and manufacturing data (e.g., a location identifier, a batch number, a reel speed of electrode tape) to an electronic file in order to link these data and spray parameters to the coated electrode via an identifier.

In one implementation, during a particular coating segment, the system can: detect a first spray parameter representing a volume flow rate of the separator material onto the electrode at the spray nozzle; detect a second spray parameter representing a speed (e.g., a line speed, a reel speed) of the electrode moving along the battery cell assembly line; and detect a third spray parameter representing an offset distance between the spray nozzle and the electrode. The system can then: generate an electronic audit trail for tracking assembly stages of this electrode along the battery cell assembly line; link a nozzle identifier, associated with the spray nozzle, to the electronic audit trail; link a second electrode identifier, associated with this electrode, to the electronic audit trail; and link the first spray parameter, the second spray parameter, and the third spray parameter to the electronic audit trail to associate these spray parameters of the particular coating segment with this electrode.

For example, the system can further: generate an electronic audit file; write a location identifier for the manufacturing facility to the electronic audit file; write a time value corresponding to the coating segment to the electronic audit file; link an identifier arranged associated with the spray-coating module or the spray nozzle to the electronic audit file; write the temperature of the separator material in the liquid state and the offset distance between the spray nozzle and the electrode to the electronic audit file; and write an electrode identifier (e.g., a serial number), corresponding to the electrode coated by this particular spray-coating module, to the electronic audit file.

Therefore, the system can link a coated electrode to manufacturing data and spray parameters, recorded prior to or during the coating segment, via an identifier arranged on the electrode. The system can further append the electronic audit file as the electrode moves along the assembly line through additional assembly stages.

### 4.2 Inspection Segment

Block S130 of the method S100 recites accessing a first inspection signal, captured by an inspection module following deposition of the separator material onto the first electrode, the first inspection signal representing characteristics of the first separator coating applied to the first electrode. Generally, in Block S130, the inspection module: records an inspection signal of the separator coating on the electrode; processes the inspection signal to characterize values of a set of coating characteristics of the separator coating; and transmits the inspection signal and the set of coating characteristics to the computer system. Alternatively, the computer system receives the inspection signal from the inspection module and processes the inspection signal to characterize a set of coating characteristics of the separator coating.

In one implementation, the system can receive the electrode coated with the separator coating in an inspection zone and initiate an inspection segment of the processing cycle at the inspection module. During the inspection segment, the system: activates the inspection module to record inspection signals representing surface characteristics of the separator coating on the electrode; and transmits these inspection signals to the computer system for characterization of coating characteristics and/or possible defects in the separator coating via the defect detection model.

In another implementation, the controller of the inspection module: activates the inspection module to record an inspection signal representing surface characteristics of the separator coating on the electrode; derives a set of coating characteristics of the separator coating from these surface characteristics of the separator coating detected in these inspection signals; and transmits the paired inspection signal and the set of coating characteristics detected in the inspection signal to the computer system. The computer system then detects possible defects in the separator coating via a defect detection model.

For example, the system can: receive a coated electrode in an inspection zone; record an inspection signal of the separator coating on the electrode via the optical sensor arranged in the inspection module; detect a defect in the inspection signal of the separator coating on the electrode based on a defect detection model; and write a flag for removal of the defect directly to an identifier arranged on the electrode and/or access the remote database to write a flag to an electronic file linked to the identifier, as further described below.

### 4.2.1 Inspection Signals

Generally, the inspection module records an inspection signal of an inspection zone occupied by an electrode coated with a separator coating. In particular, the inspection signal can include: an inspection image (e.g., photographic images, color images) captured by an optical sensor (e.g., a hyperspectral camera, a multi-spectral camera, an RGB camera) arranged in the inspection module; depth images captured by a distance sensor arranged in the inspection module; an inspection scan captured by a line scanner arranged in the inspection module; and/or a light diffraction pattern captured by an optical sensor and an optical emitter arranged in the inspection module etc.

In one implementation, the controller in the inspection module can define a shutter speed for the line scanner as a function of the production rate of coated electrodes associated with the assembly line. For example, the controller can: access an historical production rate of coated electrodes, of a particular material type, by a particular battery cell assembly line; and set a shutter speed, for the line scanner, proportional to the historical production rate of coated electrodes. During an inspection segment, the controller can trigger the line scanner to capture an inspection scan of the separator coating on the electrode at the shutter speed.

Alternatively, the controller can dynamically set a shutter speed proportional to a historical production rate of coated electrodes by a particular spray-coating module and trigger the optical sensor to capture inspection scans at this shutter speed.

### 5. Characteristics of Separator Coating

Block S142 of the method S100 recites, based on the first inspection signal, interpreting a first value of a first characteristic of the first separator coating applied to the first electrode. Generally, in Block S142, the system can: calculate a value of a characteristic of the separator coating from an inspection signal; and retrieve a target value corresponding to the electrode type from a target value database or a battery specification (e.g., a multi-cell battery for an electric vehicle, a single-cell battery for a wearable device) assigned to the battery cell assembly line associated with the electrode.

Generally, the system can characterize values of a set of coating characteristics (hereinafter “characteristics”) of the separator coating on the electrode based on these inspection signals. In particular, the system can characterize a set of characteristics of the separator coating, such as: instances of defect types (e.g., a blister defect type, a pinhole defect type, a spherical defect type, an agglomeration defect type, an uncoated edge defect type) in the separator coating; a surface roughness (“Ra”) of the separator coating; a pore morphology of the separator coating; a thickness (e.g., a single value, multiple values) of the separator coating; a pore distribution pattern across the separator coating; a pore structure, such as an arrangement of voids between pores, of the separator coating; and/or a pore size, etc.

### 5.1 Separator Coating Thickness

In particular, the system can characterize a thickness of the separator coating as a single value or multiple values. In one example, the system characterizes a thickness of a separator coating on a center of an electrode from an inspection signal. In another example, the system: characterizes a first value representing a measured thickness of the separator coating on a first edge of the electrode; characterizes a second value representing a measured thickness of the separator coating on a second edge of the electrode; and characterizes a third value representing a measured thickness of the separator coating on a center of the electrode.

In one implementation, the inspection module: receives an electrode coated with a separator coating within an inspection zone; activates an optical emitter, arranged in the inspection module, to emit an intensity of light onto the separator coating on the electrode at a first time; and records an inspection image of the inspection zone at an optical sensor arranged adjacent the optical emitter at the first time. The computer system (or the inspection module) then: accesses the inspection image of the inspection zone from the inspection module following deposition of the separator material onto the electrode; extracts a set of features from the inspection image representing characteristics of the separator coating; based on the set of features, characterizes a light diffraction pattern of the separator coating; and converts the light diffraction pattern into a thickness representing a measured thickness of the separator coating on the electrode.

Therefore, the system can: characterize a light diffraction pattern of a separator coating from features in an inspection image output by an inspection module; and convert the light diffraction pattern into a thickness of the separator coating as a single value or multiple values.

### 6. Defect Detection Model

In one implementation, the defect detection model is a deep learning model executing an artificial neural network and is configured to detect a standard set of separator coating defects that yield battery cell failures, such as electrical shorts, localized heating, incomplete contact between electrodes, etc. For example, the defect detection model can be trained to detect: one-dimensional spherical defects; bubbles, agglomerations; pinholes; clumps; grain size; discoloration; pore distribution; tears; cracks; inconsistent thickness; delamination; impurities (e.g., foreign particles embedded in the separator coating); shrinkage; scratches; surface irregularities; uncoated edges; or any other common defect in a separator coating for battery manufacturing. The system can further train the defect detection model to detect and classify defects in a separator coating at a similar camera angle (e.g., an overhead camera angle) and in images of a similar resolution to inspection signals (e.g., inspection images) recorded by the optical sensor of the inspection module.

In another implementation, the system can: receive an optical inspection signal, representing characteristics, of the separator coating on the electrode output by the optical sensor arranged in the inspection module; and characterize a characteristic of the separator coating following deposition of separator material onto the electrode based on the optical inspection signal. In this implementation, the characteristic can include: a thickness of the separator coating on the electrode; a pore morphology (or coating morphology) of the separator coating on the electrode; a surface roughness (e.g., texture) of the separator coating on the electrode; and/or a pore size, a pore distribution, or a pore structure, such as an arrangement of voids between pores, of the separator coating.

Furthermore, the system can link the characteristic to the identifier arranged on the electrode and write a flag to the identifier specifying possible defects in the separator coating on the electrode responsive to the characteristic exceeding a threshold characteristic—such as an acceptable characteristic defined by an operator or the computer system prior to a processing cycle. For example, the system can: derive a location (e.g., an (x, y) position) of a possible defect in the separator coating on the electrode; assign the location of the possible defect to a QR code arranged on the electrode; and convey the coated electrode to an optical characteristic module (e.g., a scanning electron microscope), external to the system, for further defect inspection.

Accordingly, the system can reinforce the defect detection module according to confirmation of a defect by the optical characteristic module or update the defect detection module with data captured by the optical characteristic module (e.g., a scanning electron microscope) to increase the accuracy of the defect detection module for subsequent electrodes. In particular, the system can automatically convey the coated electrode to an optical characteristic module, external to the system and the assembly line, to generate a set of training images via scanning electron microscopy techniques (e.g., electron backscatter diffraction, backscatter electron imaging, energy dispersive X-ray spectroscopy) depicting a particular defect in the separator coating on the electrode. The system can then link the set of training images, the spray parameters, the manufacturing data, and the characteristics to generate a defect detection model for this particular defect.

The system can repeat these methods and techniques for each other electrode flagged for exhibiting possible defects to generate a comprehensive defect detection model configured to detect a standard set of separator coating defects that yield battery cell failures.

### 6.1 Defect Detection+Electrode Interface Area

Blocks S140 and S150 of the method S100 recite: based on the first inspection signal, detecting a first instance of a first defect type in the first separator coating on the first electrode; and, in response to detecting the first instance of a first defect type in the first separator coating on the first electrode and in response to a first position of the first instance of the first defect type in the first separator coating on the first electrode intersecting a first electrode interface area defined for the first electrode, flagging the first electrode as defective.

Generally, in Blocks S140 and S150, the system can: access an inspection signal from the inspection module; and interpret an instance of a particular defect type in a separator coating on an electrode based on the inspection signal and the defect detection model. In particular, the system can: access an inspection scan—representing characteristics of a separator coating applied to an electrode—captured by a line scanner arranged in an inspection module; and detect a set of features representing surface irregularities in the inspection scan. Based on the first set of features and the defect detection model, the system can: detect an instance of a particular defect type in the separator coating on the electrode; and detect a position of the instance of the defect type in the separator coating, such as an (x, y) pixel location within a coordinate system of the electrode.

In one implementation, the system detects an instance of a defect type in a separator coating on an electrode. Responsive to detecting the instance of the defect type in the separator coating on the electrode and responsive to a position of the instance of the defect type intersecting an electrode interface area defined for the electrode, the system: flags the electrode as defective; and modifies the set of spray parameters to reduce a frequency of this defect type in a separator coating on a subsequent electrode.

Furthermore, the system can: access a battery specification defining geometries for stacked battery cells assembled from electrodes; and define an electrode interface area for each electrode based on the corresponding geometry defined for the electrode. For example, the system can: access a battery specification defining a rectilinear geometry of a stacked battery cell (e.g., a pouch cell) for a particular electrode; and, based on the rectilinear geometry, define an electrode interface area between a first surface of the particular electrode (e.g., a top surface of a cathode) and a second surface of a second electrode opposite the first surface (e.g., a bottom surface of an anode). The system can then: detect an instance of a defect type in a separator coating on the electrode; and, in response to a position of the instance of the defect type in the separator coating on the particular electrode intersecting a center of the first surface of the particular electrode, flag the particular electrode as defective.

The system can thus autonomously inspect separator coatings on electrodes in-line with an assembly line in order to identify and selectively discard defective electrodes prior to assembling these electrodes into battery cells.

### 6.1.1 Dimension-Based Defect Detection

In one variation, the system detects a set of defects in the separator coating on an electrode in an inspection image and characterizes a dimension of each defect in the separator coating. Responsive to the dimension exceeding a threshold dimension, the system: identifies the electrode as defective; flags the electrode for removal from the assembly line; and modifies the set of spray parameters to reduce a likelihood of a second instance of the defect in a separator coating on a subsequent electrode. Responsive to the dimension falling below the threshold dimension, the system identifies the electrode as functional and flags the electrode from assembly into a battery cell.

For example, based on a set of visual features extracted from an inspection image, the system can: detect a defect in a separator coating on an electrode; identify a pinhole defect type of the defect in the separator coating; identify a cluster of pixels in the inspection image representing the defect; calculate a dimension, such as a size, of the pinhole type defect based on the cluster of pixels; and, in response to the size exceeding the threshold size, identify the electrode as defective and store a flag for removal of the electrode from the assembly line prior to assembly into a battery cell. The system can then modify the spray parameters to reduce a likelihood of instances of these pinhole defect types in a separator coating on a subsequent electrode, as further described below.

Additionally or alternatively, in the foregoing example, the system can: detect a set of defects, of a particular defect type, in the separator coating; and detect a location and a dimension of each defect, in the set of defects, detected in the separator coating on the electrode. The system can then: calculate a size of each defect in the separator coating; calculate an average size for the set of defects; and, in response to the average size exceeding the threshold size assigned to the particular defect type, identify the electrode as defective and store a flag for removal of the electrode from the assembly line prior to assembly into a battery cell.

Therefore, the system can detect a single or multiple defects in a separator coating on an electrode and predict the likelihood of a battery cell failure resulting from a dimension and/or location of the single or multiple defects in the separator coating. Accordingly, the system can selectively flag the electrode for assembly into a battery cell or flag the electrode for removal from the assembly line.

### 6.2 Variation: Defect Detection+Confidence Scores

The system can further implement the defect detection model to detect a set of defects in an optical inspection signal of a separator coating on an electrode and to generate a confidence score for each defect. The system can thus implement the defect detection model to identify defective electrodes associated with a confidence score exceeding a threshold confidence score for flagging and removal from the assembly line.

Furthermore, the system can define a threshold confidence score, such as an acceptable target range of confidence scores defined by a user prior to the processing cycle. Alternatively, the system can dynamically select a threshold confidence score for the defect detection model based on external signals, such as the time of day, the lighting conditions in the manufacturing facility, the resolution of the optical inspection signal captured by the optical sensor arranged in the inspection module, a thickness of the separator, or any other signal accessible by the system.

In one implementation, the system inserts an optical inspection signal of a separator coating on the electrode, the spray parameters, and the characteristics of the separator coating into the defect detection model to detect a defect in the separator coating on the electrode and assign a confidence score (e.g., an integer value between 0 and 10), to the defect, representing a level of certainty of the defect. Responsive to the confidence score exceeding a threshold confidence score, the system flags (e.g., records a numeric flag, an alphanumeric flag) for removal of the electrode prior to assembly into a battery cell. Alternatively, responsive to the defective score falling below the threshold defective score, the system verifies the electrode as functional and flags the electrode for assembly into a battery cell.

For example, the system can: implement the defect detection model to identify a pinhole defect in the separator coating on the electrode from the optical inspection signal and assign a confidence score, such as nine, for the pinhole defect to the identifier arranged on the electrode; and set a threshold confidence score, such as 8, proportional to the resolution of the optical sensor arranged in the inspection module. Then, in response to the confidence score, such as 9, for the pinhole defect exceeding a threshold confidence score, such as 8, the system can: confirm the electrode as defective; read a QR code arranged on the electrode via a barcode scanner arranged in the inspection module; and write a digital numeric flag to the QR code for removal of the electrode prior to assembly into a battery cell.

In another implementation, the system implements the defect detection model to: detect a set of defects; and to generate a set of confidence scores for the set of defects. The system then calculates a composite confidence score based on (e.g., a sum of) the set of confidence scores associated with the set of defects. The system then implements the methods and techniques described above to confirm the electrode as defective or functional.

Therefore, the system can implement the defect detection model to assign confidence scores of defects in separator coatings on electrodes to identifiers and selectively sort electrodes for battery assembly or for removal along the assembly line according to these confidence scores. The system can further dynamically select a threshold confidence score to achieve accurate detection and removal of defective electrodes and to reduce the volume of discarded electrodes during the processing cycle. Additionally, rather than writing the flag to the electrode identifier on the electrode, the system can access an electronic audit trail associated with the electrode identifier of the electrode and append the electronic audit trail with the flag for removal of the electrode from the assembly line or for assembly of the electrode into a battery cell.

### 7. Upstream Closed-Loop Controls

Block S160 of the method S100 recites modifying the first set of spray parameters to reduce a likelihood of a second instance of the first defect type in a second separator coating on a second electrode in the sequence of electrodes.

Generally, in Block S160 the system: modifies (e.g., adjusts, increases, decreases) a set of spray parameters or an individual spray parameter for the particular spray-coating module to reduce a likelihood of instances of a particular defect type from occurring in a separator coating on a subsequent electrode; and selectively triggers, actuates, or activates a component of the particular spray-coating module to deposit separator material onto the subsequent electrode according to the modified set of spray parameters or the individual spray parameter.

In one implementation, the system can access a target value of a particular characteristic and assigned to an electrode type or a material type of the electrode from a target value database. In particular, the system can: receive a target value for each characteristic labeled with a material type of the electrode, such as defined by a user (e.g., an operator, an engineer); store these target values in a target value database; and identify an electrode as functional responsive to a particular characteristic value approximating a target value from the database.

Additionally, the system can receive a threshold range (e.g., a tolerance range) of acceptable values for each characteristic, defined by a user (e.g., an operator, an engineer), and identify the electrode as functional and trending toward defective responsive to a particular characteristic falling within a corresponding threshold range and deviating from the target value within the threshold range. Alternatively, the system can identify the electrode as defective responsive to the particular characteristic falling outside of the corresponding threshold range. The system can then selectively increase or decrease each spray parameter to generate a new set of spray parameters for execution by the particular spray-coating module during a next coating segment.

Therefore, the system can: characterize a particular characteristic from an inspection signal received from an inspection module arranged downstream of a particular spray-coating module; verify the electrode as functional and trending toward defective; and implement closed-loop controls to modify the set of spray parameters at the particular spray-coating module for a second electrode. The system can thus derive insights from an inspection signal output by the inspection module and modify spray parameters—output by the spray-coating module during a previous coating segment—for execution by the spray-coating module during a next coating segment in order to prevent production of a defective electrode.

### 7.1 Functional Electrode Detection

In one implementation, the system: identifies a coated electrode as functional; derives a set of relationships (e.g., a direct relationship, an indirect relationship) between each spray parameter and a particular characteristic of the separator coating on the electrode; and selectively adjusts each spray parameter at the spray-coating module in real time for subsequent electrodes. The system can repeat these methods and techniques for each other electrode over a period of time (e.g., one roll of electrodes, one hours, one day) to define a tolerance range of values of each spray parameter to yield functional coated electrodes.

For example, the system can: retrieve a flow rate of separator material at the spray nozzle onto a segment of an electrode; derive a thickness of the separator coating, (e.g., 9.9 microns) on the electrode from an optical inspection signal output by an optical sensor; and access a tolerance range representing thickness indicative of a functional electrode, such as between 9.8 microns and 10.2 microns. Then, in response to the thickness falling within the tolerance range, the system can: detect a difference between the thickness and a target thickness; calculate a target flow rate of separator material, greater than the flow rate of separator material, based on the difference; and trigger the spray nozzle to deposit separator material at the target flow rate for subsequent segments of electrodes.

In one variation, the system: interprets a value of a characteristic of a separator coating, applied to an electrode, approximating a target value specified for an electrode type of this electrode; identifies the electrode as functional; and selectively increases or decreases the spray parameter at the spray nozzle in real time for subsequent electrodes.

### 7.1.1 Surface Roughness+Spray Parameter Modification

In one variation, the system: identifies a coated electrode as functional; derives a relationship between a particular spray parameter and a surface roughness of the separator coating, such as a correlation coefficient value between −1 (e.g., negative correlation) and +1 (e.g., positive correlation) via the defect detection model; and selectively increases or decreases the spray parameter in real time for subsequent electrodes. The system can further modify the set of spray parameters to reduce a difference between a second value of the characteristic of a second separator coating applied to a second electrode and a target value assigned to the electrode type of the electrode.

In one example, the system: accesses a solvent volume ratio of the separator material at a spray nozzle, arranged in a spray-coating module, recorded during a coating segment; and executes Block 140 the method S100 to interpret a first value (e.g., an “Ra” value) of a surface roughness of the separator coating applied to the first electrode. The system then: accesses a target value of surface roughness assigned to an electrode type of the first electrode; and accesses a threshold range (e.g., a tolerance range of acceptable values) for surface roughness.

In response to the first value of surface roughness of the first separator coating applied to the first electrode falling within the first threshold range and deviating from the first target value within the first threshold range, the system: verifies the first separator coating applied to the first electrode; increases the solvent volume ratio for deposition of a second volume of the separator material onto the second electrode; and reduces the temperature of the separator material at the first spray nozzle, for deposition of the second volume of the separator material onto the second electrode in order to compensate for the first value of the surface roughness of the first separator coating applied to the first electrode (i.e., reduce the surface roughness of a subsequent separator coating).

Therefore, the system can identify a surface roughness of a separator coating on an electrode deviating from a target surface roughness and falling within a tolerance range of acceptable values. The system can identify the electrode as functional and implement closed-loop controls to selectively increase or decrease a spray parameter or a set of spray parameters at the spray-coating module to address the surface roughness of a separator coating on a subsequent electrode. The system can thus generate and implement new spray parameters at the spray-coating module in order to reduce frequency of similar functional and trending-toward-defective electrodes.

### 7.1.2 Uncoated Edge Defect Type+Spray Parameter Modification

In one variation, the system: detects absence of a separator coating on an edge of an electrode; and identifies an instance of an incomplete coverage defect type (e.g., an uncoated edge defect type) in the separator coating responsive to detecting absence of the separator coating on the edge of the electrode; and executes Blocks of the method S100 to modify the first set of spray parameters to reduce a likelihood of a second instance of the incomplete coverage defect type in a second separator coating on a second electrode.

For example, the system can: access a first inspection scan representing characteristics of a first separator coating applied to a first electrode; detect absence of the first separator coating on an edge of the first electrode based on features detected in the first inspection scan; and, in response to detecting absence of the first separator coating on the first edge of the first electrode, identify a first instance of an incomplete coverage defect type in the first separator coating on the first electrode via the defect detection model. The system can then: reduce a first spray parameter, such as a speed (e.g., a line speed, a reel speed) of the first electrode, for the second electrode; and increase a second spray parameter, such as an offset distance between the first spray nozzle and the first electrode, for the second electrode.

Thus, the system can modify spray parameters at the first spray-coating module for subsequent coating segments in order to prevent instances of incomplete coverage defects in separator coatings on similar edges of subsequent electrodes.

### 7.1.3 Blister Defect Type+Spray Parameter Modification

In one variation, the system: detects an instance of a blister defect type in a first separator coating on a first electrode based on an inspection signal; and executes Blocks of the method S100 to modify the first set of spray parameters to reduce a likelihood of a second instance of the blister defect type in a second separator coating on a second electrode.

For example, the system can access a first inspection scan representing characteristics of a first separator coating applied to a first electrode. Then, based on a set of features representing surface irregularities of the first separator coating detected in the first inspection scan, the system can: detect a circular surface discontinuity of the first separator coating applied to the first electrode; and identify the circular surface discontinuity as a first instance of a blister defect type in the first separator coating on the first electrode via the defect detection model. The system can then: reduce a first spray parameter, such as a solvent volume ratio, for deposition of a second volume of the separator material onto a second electrode at the first spray nozzle; and reduce a second spray parameter, such as a temperature of the separator material, at the first spray nozzle for the second electrode.

Thus, the system can modify spray parameters at the first spray-coating module for subsequent coating segments in order to prevent instances of blister defect types in separator coatings applied to subsequent electrodes.

### 7.1.4 Run-Off Defect Type+Spray Parameter Modification

In one variation, the system: detects an instance of a run-off defect type in a first separator coating on a first electrode based on an inspection signal; and executes Blocks of the method S100 to modify the first set of spray parameters to reduce a likelihood of a second instance of the run-off defect type in a second separator coating on a second electrode.

For example, the system can: detect an instance of a run-off defect type in a first separator coating on a first electrode based on a set of visual features detected in an inspection scan of the first separator coating; and, in response to a position of the instance of the run-off defect type in the first separator coating on the first electrode intersecting an electrode interface area defined for the first electrode, flag the first electrode as defective. The system can then: reduce a first spray parameter, such as a volume flow rate, for deposition of a second volume of the separator material onto the second electrode at the first spray nozzle; and increase a second spray parameter, such as a temperature of the coating zone, to evaporate the solvent out of a second volume of the separator material prior to contact with the second electrode (e.g., via a heater arranged in the spray-coating module).

Thus, the system can modify the volume flow rate of separator material and the temperature of the coating zone in order to reduce a likelihood of a second instance of the run-off defect type in a second separator coating (e.g., over-deposition of the separator material onto the second electrode).

### 7.1.5 Other Characteristics+Spray Parameter Modification

The system can implement methods and techniques described above to: interpret each characteristic of a separator coating on an electrode from an inspection signal; and selectively increase or decrease the set of spray parameters in real time for subsequent electrodes.

Additionally or alternatively, the system can interpret a set of characteristics of a separator coating on an electrode from an inspection signal; and selectively increase or decrease the set of spray parameters to reduce the frequency of similar characteristic differences for subsequent electrodes.

### 7.2 Defective Electrode Detection

In one implementation, in response to a characteristic, in a set of characteristics, of the separator coating falling outside of the tolerance range, the system can: insert an inspection signal and the set of characteristics into the defect detection model to detect a possible defect in the separator coating on the electrode; identify the coated electrode as defective; store a flag for removal of the electrode from the assembly line prior to assembly into a battery cell; and advance the coated electrode along the assembly line for removal downstream of the optical inspection station, as further described below.

In one example, the system executes Blocks of the method S100 to characterize a thickness of the separator coating and, in response to the thickness exceeding a target thickness: access an electronic audit trail including an identifier associated with the electrode; generate a flag for removal of the electrode from the assembly line; and append the electronic audit trail with flag to associate the flag with the electrode identifier.

Therefore, the system can identify a characteristic of a separator coating on a segment of an electrode deviating from a tolerance range of acceptable values, identify the electrode as defective, and flag the electrode for removal.

### 8. Downstream Closed-Loop Controls

Generally, the system: modifies the set of spray parameters or an individual spray parameter for a second spray-coating module arranged downstream of the first spray-coating module; and selectively triggers, actuates, or activates a component of the second spray-coating module to deposit an additional volume of the separator material over a separator coating on an electrode according to the modified set of spray parameters or the individual spray parameter.

In one implementation, the system: identifies a coated electrode as functional; derives a relationship between a set of spray parameters and a pore distribution pattern of the separator coating, such as a correlation coefficient value between −1 (e.g., negative correlation) and +1 (e.g., positive correlation) via the defect detection model; and selectively increases or decreases the set of spray parameters at a downstream spray-coating module in real time to deposit a second separator coating on this electrode.

Therefore, rather than modifying a set of spray parameters at a particular spray-coating module to generate a second set of spray parameters that decreases a difference between a characteristic and a target characteristic for a second electrode, the system can define new set of spray parameters as a target set for a spray-coating module arranged downstream of the particular spray-coating module.

### 8.1 Pore Defect Type Example

In one example, the system: deposits a volume of the separator material (e.g., the polymer-polymer-solvent mixture) onto an electrode; interprets a dimension of a first pore of a pore defect type of the separator coating applied to the electrode from an inspection signal; accesses a target size associated with the polymer-polymer-solvent mixture; reduces a temperature of the separator material, at a second spray nozzle inversely proportional to the first dimension of the first pore; increases a solvent volume ratio, proportional to the first dimension of the first pore for deposition of the second volume of the separator material onto the first separator coating on the first electrode; advances the first electrode through a second coating zone downstream of the first coating zone; and, at the second spray nozzle facing the second coating zone, deposits a second volume of the separator material onto the first separator coating on the first electrode, occupying the second coating zone, according to the modified temperature and solvent volume ratio to form a second separator coating over the first separator coating on the first electrode that fills the pore.

Accordingly, the system can execute Blocks of the method S100 to: access a second inspection signal—representing characteristics of the second separator coating applied to the first electrode—captured by the inspection module following deposition of the second volume of the separator material onto the first electrode; detect absence of a second instance of the pore defect type in the second separator coating on the first electrode; and, in response to detecting absence of the second instance of the pore defect type in the second separator coating, remove a first flag indicating the first electrode as defective and release the first electrode for assembly into a battery cell.

Therefore, the system can implement closed-loop controls to define a new set of spray parameters for a spray-coating module arranged downstream of the particular spray-coating module to spray-coat an additional separator coating over the first separator coating to fill pores of the pore defect type in the first separator coating on the first electrode.

### 8.2 Surface Roughness Defect Type Example

In one example, the system: accesses a solvent volume ratio of the separator material at a spray nozzle, arranged in a spray-coating module, recorded during a coating segment; and executes Block 140 the method S100 to interpret a first value (e.g., an “Ra” value) of a surface roughness of the separator coating applied to the first electrode. The system then: access a target thickness assigned to an electrode type of the first electrode; and access a threshold range (e.g., a tolerance range of acceptable values) for surface roughness.

In response to the first value of surface roughness of the first separator coating applied to the first electrode falling within the first threshold range and deviating from the first target value within the first threshold range, the system: verifies the first separator coating applied to the first electrode; and defines a second set of spray parameters for a second spray nozzle, arranged downstream of the first spray nozzle, to compensate for the first value of the first surface roughness of the first separator coating. In particular, the system: increases the solvent volume ratio for deposition of a second volume of the separator material onto the second electrode; and reduces the temperature of the separator material at the first spray nozzle for deposition of the second volume of the separator material onto the second electrode in order to compensate for the first value of the surface roughness of the first separator coating applied to the first electrode (i.e., reduce the surface roughness of a subsequent separator coating.

Accordingly, the system executes Blocks of the method S100 to: advance the sequence of electrodes through a second coating zone; and, at the second spray nozzle, deposit the second volume of the separator material onto the first electrode, occupying the second coating zone, over the first separator coating according to the second set of spray parameters.

Therefore, the system can define a new set of spray parameters as a target set for a spray-coating module arranged downstream the particular spray-coating module to spray-coat an additional separator coating over the first separator coating to correct the surface roughness of the first separator coating on the first electrode.

### 9. Verification of Functional Coated Electrodes

In one implementation, the system reads the flag linked to the identifier of the coated electrode and conveys the coated electrode along the assembly line and downstream of the inspection module for assembly into a battery cell.

Furthermore, the system can: receive the coated electrode, in a sequence of coated electrodes, in a scan volume downstream the spray-coating module; read an optical code on the electrode, through the separator coating, via a barcode scanner facing the scan volume; interpret an electrode identifier from the optical code; retrieve the electronic audit file associated with the electrode identifier; and, in response to a flag specifying assembly of the coated electrode into a battery cell, convey the coated electrode along the assembly line for assembly into a battery cell.

Thus, the system can selectively convey a coated electrode for further production into a battery cell of a two-dimensional or three-dimensional battery (e.g., a pouch cell) according to metadata linked to the identifier arranged on the coated electrode.

### 10. Discard Defective Electrodes

Generally, the system can include a single defective electrode container (e.g., a waste bin) per scan volume, per set of inspection modules, per set of removal modules, or per individual inspection module. Further, the defective electrode container is arranged below the assembly line and configured to store defective coated electrodes from the assembly line at the conclusion of the processing cycle.

In one implementation, the system: receives the coated electrode, in a sequence of coated electrodes, in a scan volume downstream of the spray-coating module; reads an optical code on the electrode, through the separator coating, via a barcode scanner facing the scan volume; interprets an electrode identifier from the optical code; retrieves the electronic audit file associated with the electrode identifier; and, in response to a flag specifying removal of the coated electrode, discard the coated electrode from the assembly line into a coated electrode container (e.g., a waste bin) at the conclusion of the processing cycle.

The system can repeat the methods and techniques described above for each other coated electrode in the sequence of coated electrodes to discard defective electrodes from the assembly line prior to assembly into a battery cell. The system can thus reduce battery cell waste from battery cell production by discarding defective electrodes prior to battery cell production.

For example, the system can: receive a coated electrode, in a sequence of coated anodes, in a scan volume downstream of the spray-coating module; read the flag linked to the barcode arranged on the coated electrode via the barcode scanner facing the scan volume; and, in response to the flag specifying removal of the coated electrode (or indicating the coated electrode as defective), discard the coated electrode from the assembly line to a coated electrode container (e.g., a waste bin) at the conclusion of the processing cycle.

Therefore, the system can rapidly and selectively discard a defective electrode from the assembly line in real time according to metadata linked to the identifier arranged on the coated electrode.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
advancing a sequence of electrodes through a first coating zone;
at a first spray nozzle facing the first coating zone, depositing a first volume of a separator material onto a first electrode, in the sequence of electrodes and occupying the first coating zone, according to a first set of spray parameters to form a first separator coating on the first electrode;
accessing a first inspection signal captured by an inspection module following deposition of the separator material onto the first electrode, the first inspection signal representing characteristics of the first separator coating applied to the first electrode;
based on the first inspection signal, detecting a first instance of a first defect type in the first separator coating on the first electrode; and
in response to detecting the first instance of a first defect type in the first separator coating on the first electrode:
in response to a first position of the first instance of the first defect type in the first separator coating on the first electrode intersecting a first electrode interface area defined for the first electrode, flagging the first electrode as defective; and
modifying the first set of spray parameters to reduce likelihood of a second instance of the first defect type in a second separator coating on a second electrode in the sequence of electrodes.

2. The method of claim 1, further comprising:
advancing the sequence of electrodes through a second coating zone;
at a second spray nozzle facing the second coating zone, depositing a second volume of the separator material onto the second electrode, in the sequence of electrodes and occupying the second coating zone, according to the first set of spray parameters to form a second separator coating on the second electrode;
accessing a second inspection signal captured by the inspection module following deposition of the second volume of the separator material onto the second electrode, the second inspection signal representing characteristics of the second separator coating applied to the second electrode;
based on the second inspection signal, detecting absence of a second instance of the first defect type in the second separator coating on the second electrode; and
in response to detecting absence of the second instance of the first defect type in the second separator coating, releasing the second electrode for assembly into a battery cell.

3. The method of claim 1:
wherein detecting the first instance of the first defect type in the first separator coating comprises, based on the first inspection signal, detecting the first instance of a pore defect type in the first separator coating on the first electrode; and
wherein modifying the first set of spray parameters to reduce likelihood of the second instance of the first defect type in the second separator coating comprises:
reducing a first spray parameter, in the first set of spray parameters and comprising a first solvent volume ratio, for deposition of a second volume of the separator material onto the second electrode at the first spray nozzle; and
increasing a second spray parameter, in the first set of spray parameters and comprising a first temperature of the separator material at the first spray nozzle, for the second electrode.

4. The method of claim 3, further comprising:
defining a second set of spray parameters for a second spray nozzle, arranged downstream of the first spray nozzle, to fill the first instance of the pore defect type in the first separator coating by:
increasing a second temperature at the second spray nozzle; and
reducing a second solvent volume ratio for deposition of a third volume of the separator material onto the first electrode;
advancing the sequence of electrodes through a second coating zone; and
at the second spray nozzle, depositing the third volume of the separator material onto the first electrode, occupying the second coating zone, over the first separator coating according to the second set of spray parameters.

5. The method of claim 4, further comprising:
accessing a second inspection signal captured by the inspection module following deposition of the second volume of the separator material onto the first electrode, the second inspection signal representing characteristics of the second separator coating applied to the first electrode;
based on the second inspection signal, detecting absence of a second instance of the first defect type in the second separator coating on the first electrode; and
in response to detecting absence of the second instance of the first defect type in the second separator coating:
removing a first flag indicating the first electrode as defective; and
releasing the first electrode for assembly into a battery cell.

6. The method of claim 1:
wherein detecting the first instance of the first defect type in the first separator coating comprises, based on the first inspection signal:
detecting absence of the first separator coating on a first edge of the first electrode; and
in response to detecting absence of the first separator coating on the first edge of the first electrode, identifying the first instance of an incomplete coverage defect type in the first separator coating on the first electrode; and
wherein modifying the first set of spray parameters to reduce likelihood of the second instance of the first defect type in the second separator coating comprises:
reducing a first spray parameter, in the first set of spray parameters and comprising a first speed of the first electrode, for the second electrode; and
increasing a second spray parameter, in the first set of spray parameters and comprising a first offset distance between the first spray nozzle and the first electrode, for the second electrode.

7. The method of claim 1:
wherein detecting the first instance of the first defect type in the first separator coating comprises based on the first inspection signal, detecting the first instance of a blister defect type in the first separator coating on the first electrode; and
wherein modifying the first set of spray parameters to reduce likelihood of the second instance of the first defect type in the second separator coating comprises:
reducing a first spray parameter, in the first set of spray parameters and comprising a first solvent volume ratio, for deposition of a second volume of the separator material onto the second electrode at the first spray nozzle; and
reducing a second spray parameter, in the first set of spray parameters and comprising a first temperature of the separator material, at the first spray nozzle for the second electrode.

8. The method of claim 1:
wherein detecting the first instance of the first defect type in the first separator coating comprises based on the first inspection signal, detecting the first instance of a run-off defect type in the first separator coating on the first electrode; and
wherein modifying the first set of spray parameters to reduce likelihood of the second instance of the first defect type in the second separator coating comprises:
reducing a first spray parameter, in the first set of spray parameters and comprising a first volume flow rate, for deposition of a second volume of the separator material onto the second electrode at the first spray nozzle; and
increasing a second spray parameter, in the first set of spray parameters and comprising a first temperature of the coating zone, for the second electrode.

9. The method of claim 1:
further comprising:
accessing a battery specification defining a rectilinear geometry of a stacked battery cell for the first electrode; and
based on the rectilinear geometry of the stacked battery cell, defining a first electrode interface area between a first surface of the first electrode and a second surface of a second electrode opposite the first surface; and
wherein flagging the first electrode as defective comprises, in response to the first position of the first instance of the first defect type in the first separator coating applied to the first electrode intersecting a center of the first surface of the first electrode, flagging the first electrode as defective.

10. The method of claim 1:
further comprising, at the inspection module following deposition of the first volume of the separator material onto the first electrode, recording a first inspection scan of the first separator coating on the first electrode via a line scanner arranged in the inspection module;
wherein accessing the first inspection signal captured by the inspection module comprises accessing the first inspection scan captured by the line scanner from the inspection module, the first inspection scan representing characteristics of the first separator coating applied to the first electrode; and
wherein detecting the first instance of the first defect type in the first separator coating on the first electrode comprises:
detecting a first set of features representing surface irregularities in the first inspection scan; and
based on the first set of features:
detecting the first instance of the first defect type in the first separator coating on the first electrode; and
detecting the first position of the first instance of the first defect type in the first separator coating on the first electrode.

11. The method of claim 10:
wherein advancing the sequence of electrodes through the first coating zone comprises advancing the sequence of electrodes, of a first material type, through the first coating zone along a battery cell assembly line;
further comprising:
accessing a historical production rate of coated electrodes of the first material type and associated with the battery cell assembly line; and
setting a shutter speed proportional to the historical production rate of coated electrodes of the first material type for the line scanner; and
wherein recording the first inspection scan of the first separator coating on the first electrode comprises recording the inspection scan of the first separator coating on the first electrode at the shutter speed via the line scanner.

12. The method of claim 1, wherein depositing the separator material onto the first electrode comprises:
at the first spray nozzle, spray-coating the first volume of the separator material onto the first electrode, the first volume of the separator material comprising a first solvent, a first polymer, and a second polymer;
heating the first electrode and the first volume of the separator material to evaporate the first solvent out of the first volume of the separator material; and
irradiating the first volume of the separator material located on the first electrode to crosslink the first polymer and form the first separator coating on the first electrode.

13. The method of claim 1:
further comprising:
reading a first optical code on the first electrode at a camera arranged upstream of the first spray nozzle;
interpreting a first electrode identifier from the first optical code;
generating a first electronic audit trail for tracking assembly stages of the first electrode;
linking the first electrode identifier to the first electronic audit trail; and
linking the first set of spray parameters to the first electronic audit trail to associate the first set of spray parameters with the first electrode; and
wherein flagging the first electrode as defective comprises:
generating a first flag indicating the first electrode as defective;
recording the first flag associated with the first electrode identifier in the first electronic audit trail; and
storing the first electronic audit trail in an audit database.

14. The method of claim 1, wherein depositing the first volume of the separator material onto the first electrode comprises:
driving a voltage difference between the first spray nozzle, coupled to a reservoir comprising volumes of the separator material, and the first electrode; and
at the first spray nozzle, dispensing a volume of separator material over the first electrode to electrically charge separator material droplets within the volume of separator material existing at the spray nozzle, the separator material droplets electrostatically drawn onto the first electrode to apply the volume of separator material across the first electrode via the voltage difference.

15. A method comprising:
advancing a sequence of electrodes through a coating zone;
at a first spray nozzle facing the coating zone, depositing a first volume of a separator material onto a first electrode, in the sequence of electrodes and occupying the coating zone, according to a first set of spray parameters to form a first separator coating on the first electrode;
accessing a first inspection signal captured by an inspection module following deposition of the first volume of the separator material onto the first electrode, the first inspection signal representing a first characteristic of the first separator coating applied to the first electrode;
based on the first inspection signal, interpreting a first value of the first characteristic of the first separator coating applied to the first electrode; and
in response to the first value of the first characteristic of the first separator coating applied to the first electrode falling within a first threshold range and deviating from a first target value within the first threshold range:
verifying the first separator coating applied to the first electrode; and
modifying the first set of spray parameters to reduce a difference between:
a second value of the first characteristic of a second separator coating applied to a second electrode; and
the first target value.

16. The method of claim 15:
wherein accessing the first inspection signal captured by the inspection module comprises accessing the first inspection signal representing the first characteristic comprising a first surface roughness of the first separator coating applied to the first electrode;
wherein interpreting the first value of the first characteristic of the first separator coating comprises based on the first inspection signal, interpreting the first value of the first surface roughness of the first separator coating applied to the first electrode; and
wherein modifying the first set of spray parameters comprises:
increasing a first spray parameter, in the first set of spray parameters and comprising a first solvent volume ratio, for deposition of a second volume of the separator material onto the second electrode; and
reducing a second spray parameter, in the set of spray parameters and comprising a temperature of the separator material at the first spray nozzle, for deposition of the second volume of the separator material onto the second electrode.

17. The method of claim 16, further comprising:
defining a second set of spray parameters for a second spray nozzle, arranged downstream of the first spray nozzle, to compensate for the first value of the first surface roughness of the first separator coating by:
reducing a second temperature at the second spray nozzle; and
increasing a second solvent volume ratio for deposition of a third volume of the separator material onto the first electrode;
advancing the sequence of electrodes through a second coating zone; and
at the second spray nozzle, depositing the third volume of the separator material onto the first electrode, occupying the second coating zone, over the first separator coating according to the second set of spray parameters.

18. The method of claim 15:
further comprising, at the inspection module:
activating an optical emitter, arranged in the inspection module, to emit a first intensity of light onto the first separator coating on the first electrode at a first time; and
recording an inspection image of the inspection zone at an optical sensor arranged adjacent the optical emitter at approximately the first time;
wherein accessing the first inspection signal captured by the inspection module comprises accessing the inspection image from the inspection module; and
wherein interpreting the first value of the first characteristic of the first separator coating comprises:
based on a set of features detected in the inspection image, characterizing a light diffraction pattern of the first separator coating on the first electrode; and
converting the light diffraction pattern into the first value of a first thickness of the first separator coating on the first electrode.

19. A method comprising:
advancing a first electrode through a first coating zone;
at a first spray nozzle facing the first coating zone, depositing a first volume of a separator material onto the first electrode, occupying the first coating zone, according to a first set of spray parameters to form a first separator coating on the first electrode;
accessing a first inspection signal captured by an inspection module following deposition of the separator material onto the first electrode, the first inspection signal representing a first characteristic of the first separator coating applied to the first electrode;
based on the first inspection signal, interpreting a first value of the first characteristic of the first separator coating applied to the first electrode;
modifying a second set of spray parameters to compensate for the first value of the first characteristic of the first separator coating applied to the first electrode;
advancing the first electrode through a second coating zone downstream of the first coating zone; and
at a second spray nozzle facing the second coating zone, depositing a second volume of the separator material onto the first separator coating on the first electrode, occupying the second coating zone, according to the second set of spray parameters to form a second separator coating over the first separator coating on the first electrode.

20. The method of claim 19:
wherein accessing the first inspection signal captured by the inspection module comprises accessing the first inspection signal representing the first characteristic comprising a first pore of the first separator coating applied to the first electrode;
wherein interpreting the first value of the first characteristic of the first separator coating comprises based on the first inspection signal, interpreting a first dimension of the first pore of the first separator coating applied to the first electrode; and
wherein modifying the second set of spray parameters to compensate for the first value of the first characteristic comprises modifying the second set of spray parameters to fill the first pore of the first separator coating applied to the first electrode by:
increasing a first spray parameter, in the second set of spray parameters and comprising a first temperature of the separator material, at the second spray nozzle inversely proportional to the first dimension of the first pore; and
reducing a second spray parameter, in the second set of spray parameters and comprising a first solvent volume ratio, proportional to the first dimension of the first pore for deposition of the second volume of the separator material onto the first separator coating on the first electrode.
